(19) United States
(12) Patent Application Publication
(10) Pub. No.: US 2005/0261028 A1
(43) Pub. Date: Nov. 24, 2005

(54) Smart antenna for generating nested beams

(75) Inventor: Prabhakar R. Chitrapu, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/902,357

(22) Filed: Jul. 29, 2004

Related U.S. Application Data
(60) Provisional application No. 60/573,539, filed on May 21, 2004.

(51) Int. Cl. H04B 7/185

(52) U.S. Cl. 455/562.1

(57) ABSTRACT

A smart antenna is disclosed for generating nested beams. The antenna is configured to generate a cover beam and a center beam. The cover beam has a wide coverage area and the center beam, which is nested within the cover beam, has a narrow coverage area. Both the cover beam and the center beam may be independently steerable or steered jointly as if coupled together. The cover beam is preferably used for system-wide purposes, such as multicasting, broadcasting, paging, tracking, and physical measurements. The center beam is preferably used for exchanging data between a transmitter and receiver. However, the cover beam and the center beam may also be used for transmission of data and signaling traffic respectively.

### CROSS REFERENCE TO RELATED APPLICATION

This application claims the benefit of U.S. provisional application No. 60/573,539 filed May 21, 2004, which is incorporated by reference as if fully set forth.

### FIELD OF INVENTION

The present invention is related to wireless communication systems. More particularly, the present invention is related to smart antennas for generating nested beams.

### BACKGROUND

Wireless communication systems typically comprise base stations and wireless transmit/receive units (WTRUs). Both base stations and WTRUs are equipped with antennas for transmission and reception of signals. Smart antennas have been developed and widely used to enhance the efficiency in transmission and reception of signals through the use of beams.

Referring initially to FIG. 1, there is shown a conventional base station 100 having a beam forming antenna 101 (i.e. smart antenna). Beams are emanated from a smart antenna 101 with varying degrees of width or coverage area and there are tradeoffs between narrow beams 104 and wide beams 102. Narrow beams 104 are particularly efficient where a link has already been established with a WTRU and you want to maximize throughput and/or minimize interference. Narrow beams 104, however, have smaller coverage areas making them more likely to need to be adjusted when a WTRU changes location. Wide beams 102, in contrast, are more efficient than narrow beams for paging, multicast, and broadcast messages as well as initial call set up processes (i.e. handshaking) because of their wider coverage area. Further, wide beams 102 are less likely to need to be adjusted based on WTRU movement because WTRUs are more likely to remain within the wider coverage area of a wide beam 102.

It would therefore be desirable to provide a beam that combines the benefits of wide beams and narrow beams.

### SUMMARY

The present invention is related to smart antennas for generating nested beams. The antennas are configured to generate a cover beam and a center beam. The cover beam has a wide coverage area and the center beam, which is nested within the cover beam, has a narrow coverage area. Both the cover beam and the center beam may be independently steerable or steered jointly as if coupled together. The cover beam is preferably used for system-wide purposes, such as multicasting, broadcasting, paging, tracking, and physical measurements. The center beam is preferably used for exchanging data between a transmitter and receiver. However, the cover beam and the center beam may also be used for transmission of data and signaling traffic respectively.

### BRIEF DESCRIPTION OF THE DRAWINGS

FIG. 1 is a diagram of beams of varying width emanating from a conventional smart antenna.

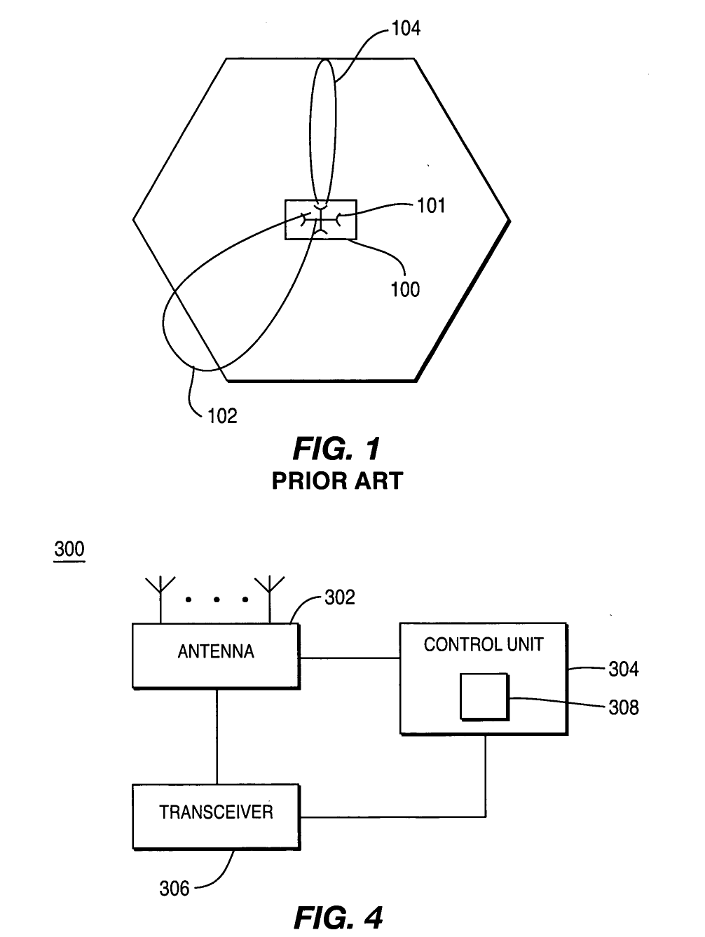

FIG. 2 is a perspective view of a nested beam emanating from a smart antenna in accordance with the present invention.

FIGS. 3A and 3B show a wireless communication system wherein nested beams are used to enhance wireless communications in accordance with the present invention.

FIG. 4 is a block diagram of a system for generating a nested beam in accordance with the present invention.

### DETAILED DESCRIPTION OF THE PREFERRED EMBODIMENTS

The present invention will be described with reference to the drawing figures wherein like numerals represent like elements throughout. Herein, a wireless transmit/receive unit (WTRU) includes but is not limited to a user equipment, a mobile station, a fixed or mobile subscriber unit, a pager, or any other type of device capable of operating in a wireless environment. When referred to herein, a base station includes but is not limited to a Node-B, a site controller, an access point or any other type of interfacing device in a wireless environment. When referred to herein, a smart antenna, which includes adaptive antennas, may be referred to and used interchangeably with “antenna.” Further, an antenna includes an antenna array, set of antenna elements, or any other type of antenna structure.

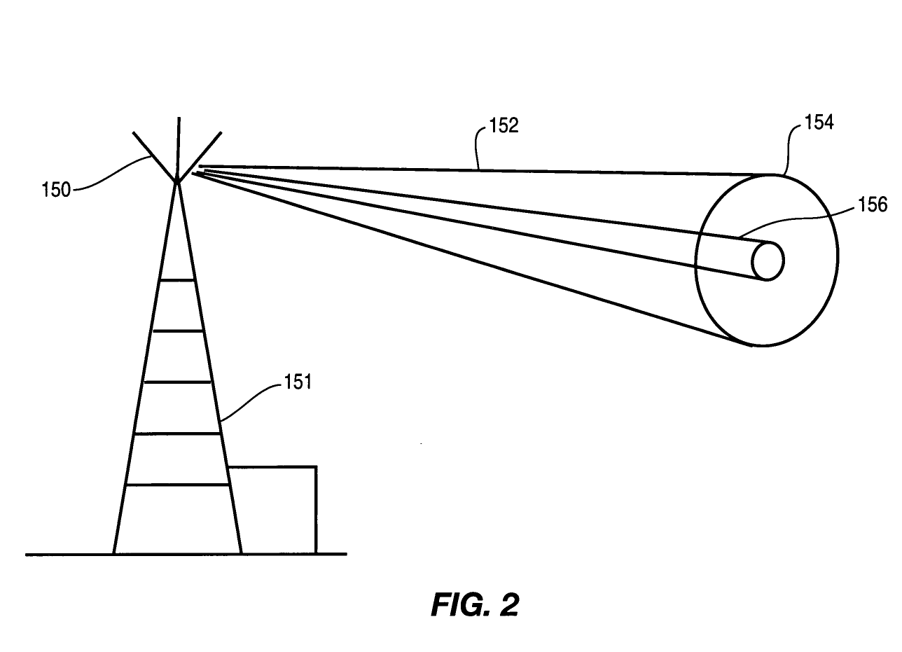

Referring now to FIG. 2, there is shown a perspective view of base station 151 having an antenna 150 radiating a nested beam 152 in accordance with the present invention. The nested beam 152 includes a cover beam 154 and at least one center beam 156. The cover beam 154 has a wider coverage area than the center beam 156, and the center beam 156 is nested within the cover beam 154. Both the cover beam 154 and center beam 156 may be adjusted in the azimuth and/or elevation directions.

When the cover beam 154 is adjusted or otherwise moved, the center beam 156 preferably moves along with the cover beam 154 as if they are coupled together. However, both the cover beam 154 and the center beam 156 are independently steerable so that the center beam 156 may move independently within the cover beam 154.

The cover beam 154 is preferably radiated with a low gain but wide coverage. The center beam 156 is preferably radiated with a high gain but narrow coverage. The cover beam 154 and the center beam 156 are preferably used for different purposes and may be utilized in a coordinated fashion to enhance communications between a transmitter and a receiver.

The center beam 156 is preferably used for transmission/reception of user data and is steered to focus on a particular WTRU or base station. Since the center beam 156 has a narrow coverage area, it generally generates less interference compared to handling user data with beams having wider coverage areas. The cover beam 154 may be used, for example, for transmissions directed to groups of WTRUs, broadcasts, WTRU tracking, various system management purposes, and/or any other types of functions most efficiently performed using a beam having a wide coverage area. The cover beam 154 may also be used to provide WTRU-specific physical measurements to enhance data transmission/reception within one or more center beams 156 nested within the cover beam 154.

By way of example, the cover beam 154 may be used for paging purposes for WTRUs operating within the coverage area of the cover beam 154. During a paging process, when a network is trying to locate a WTRU whose location is not known to the network, a cover beam 154 is preferably used due to its wider coverage area. It is more efficient to use a wide beam rather than a narrow beam for paging purposes because paging signals are typically transmitted throughout a coverage area to find a target WTRU. Even though paging signals are transmitted to a wide coverage area, the paging process typically consists of an exchange of signaling messages having only low amounts of data. Therefore, use of the cover beam 154 for paging purposes does not generate excessive load or interference on the system, despite its wide coverage area.

After the WTRU has been located and the direction to the WTRU within the cover beam is found using the cover beam 154, the system steers a center beam 156 nested within the cover beam 154 to the direction of the WTRU, and utilizes the center beam 156 for transmission/reception of user data to/from the WTRU. The center beam 156 is preferably steered to focus on the WTRU to transmit/receive larger amounts of data at higher data rates. With this scheme, the system may efficiently locate the WTRU using a cover beam 154, while providing sufficient quality of service to the WTRU using a center beam 156, without generating excessive load or interference in the system. As explained in more detail below, paging functions may also be performed using an omni-directional beam where an omni-directional beam is deployed along with a nested beam 152.

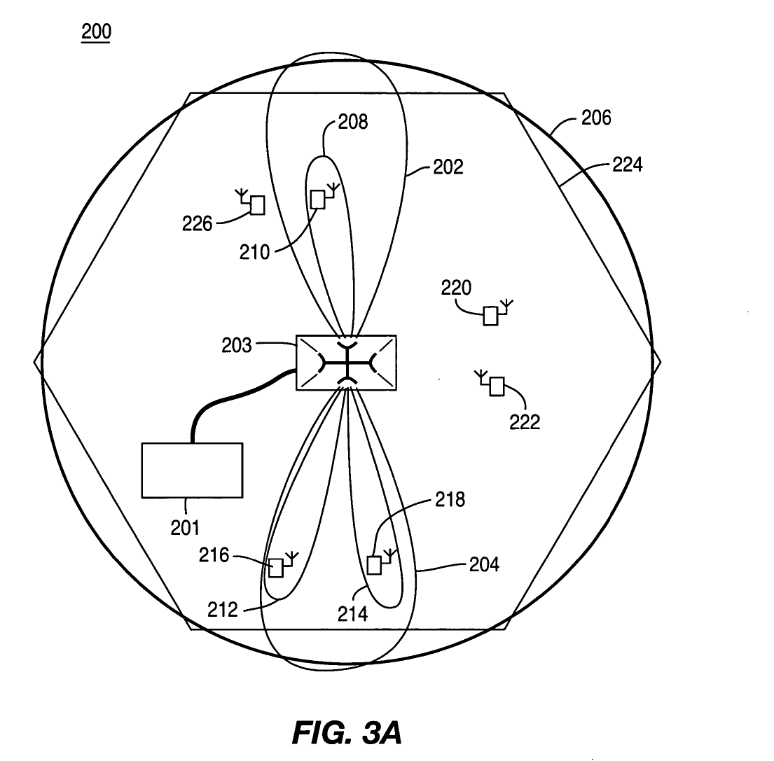

Referring now to FIG. 3A, there is shown a wireless communication system 200 in accordance with the present invention. The system 200 includes at least one base station 203, at least one controller 201, and a plurality of WTRUs 210, 216, 218, 220, 222, 226. The base station 203 is shown emanating two cover beams 202, 204 along with an omni-directional beam 206. Cover beam 202 includes one center beam servicing WTRU 210 and cover beam 204 includes two center beams 212, 214 serving WTRUs 216, 218, respectively. It is noted that each WTRU shown herein may represent a single WTRU or a group of WTRUs wherein the group may include any number of WTRUs.

The omni-directional beam 206 is preferably used for initial handshaking procedures when WTRUs such as 220, 222 begin operating within the coverage area 224 provided by base station 200. The omni-directional beam 206 may also be used for paging, broadcasting, or multicasting purposes where such messages are to be delivered to WTRUs that are associated with more than one cover beam. For example, a paging message that is to be delivered to WTRUs 210 and 216 may be delivered using the omni-directional beam 206. Where WTRUs 216, 218 are the recipients of a paging message, the messages may be delivered using the cover beam 204 or the omni-directional beam 206. The omni-directional beam 206 may also be used to locate WTRUs 220, 222, 226 operating outside the range of cover beams 202, 204, as explained in more detail below.

Generally, WTRUs are constantly moving and wireless communication systems typically track their movements for various purposes including maintaining an appropriate level of quality of service (QOS). In the present invention, WTRU movement is preferably tracked using a cover beam so that center beams within the cover beam may be adjusted with greater intelligence. For example, in FIG. 3A, the base station 200 periodically receives signals from a WTRU, say WTRU 216, through the cover beam 204. The system 200 performs an analysis to determine the direction of arrival of at least one signal received from WTRU 216. According to the determined direction of arrival, the center beam 212 is steered to the location of the WTRU 216, as needed, for transmission/reception of data. Therefore, when the WTRU 216 changes position, as shown in FIG. 3B, the center beam 216 (shown in dashed lines to show its new position) may be adjusted to remain focused on the WTRU 216. In this embodiment, the tracking and data transmission/reception functions are split between the cover beam 204 and the center beam 212, respectively. This ensures that each function is performed by the type of beam that may most efficiently perform the particular function. It is important to note that the scenario described above is provided by way of example and the teachings provided therein (i.e. performing particular functions using beams best suited for performance of the particular functions) may be implemented as desired between center and cover beams regardless of what particular functions are being performed.

As a WTRU changes location, the conditions of a wireless connection (i.e. wireless conditions) also changes. Therefore, to maintain acceptable levels of QOS when WTRUs change location, various parameters often need to be adjusted. For example, when wireless conditions change based on a change in WTRU location, parameters that may need to be adjusted include, but are not limited to, transmission power levels, beam directions, bit rates, target signal-to-interference ratios, or the like. In order to adjust such transmission parameters, a system needs several physical measurements. Purely by way of example, the type of physical measurements that may be needed include signal power level, signal to noise ratio, interference level, channel estimate, channel quality factor, etc.

Referring again to FIG. 3A, cover beams 202, 204 are preferably used to perform the necessary physical measurements described above. Performance of physical measurements by cover beams 202, 204 enable such measurements to be performed on a WTRU-specific basis. This is because since each cover beam 202, 204, preferably tracks the location of its WTRUs, the performance of physical measurements is performed taking into account a WTRU's position or anticipated position. The physical measurements are used by the system 200 such that advance notice is provided where any adjustments need to made for any center beams to maintain data transmission/reception at an acceptable level of QOS.

For example, where WTRU 216 changes positions between FIGS. 3A and 3B as explained above, the system 200 computes an expected location of WTRU 216 and performs physical measurements using information obtain through cover beam 204 at the expected location before the WTRU 216 actually reaches the expected location. Because the cover beam 204 enables the system 200 to obtain advance information about the wireless conditions the WTRU 216 will be operating in when WTRU 216 changes location, the system 200 is capable of adjusting transmission parameters of the center beam 212 more rapidly. Therefore, in this scenario, the cover beam 204 serves to illuminate a wider area, within which the center beams 212, 214 may be steered, with advance information about upcoming wireless conditions.

The omni-directional beam 206 may be beneficial wherein cover beams need to be adjusted or new cover beams need to be deployed to bring additional WTRUs 220, 222, 226 within the coverage areas of a cover beam. For example, in FIG. 3A, WTRU 226 is outside of cover beam 202. However, omni-directional beam 206 may be used to obtain location information regarding WTRU 226. Based on the location information, the system 200 may adjust cover beam 202 and deploy an additional center beam 228 focused on WTRU 226. With respect to WTRUs 220, 222, the system 200 may deploy a new cover beam 230 and two additional center beams 232, 234. Of course, cover beams may be of any size as desired. Therefore, WTRU 226 may be provided service with a new cover beam and a new center beam. Similarly, cover beam 202, 204 or a combination of the two may be adjusted and two new center beams deployed to service WTRUs 232, 234.

It is noted that while the cover beams shown in FIGS. 3A and 3B cover only a portion of the coverage area 224, a base station 203 may be configured to deploy any number of cover beams of any size such that cover beam coverage is provided throughout a coverage area 224. In such an embodiment, as with the embodiment described above, the cover beams may be deployed with or without an omni-directional beam. In the embodiment described above, if no omni-directional beam 206 is provided, the cover beams 202, 204 may be swept through the coverage area 224 to pick up new users so that existing cover beams may be adjusted or additional cover beams may be deployed, where necessary. Where cover beam coverage is provided throughout a coverage area, an omni-directional beam is obviously not required. However, where an omni-directional beam is not provided, the initial handshaking functions will need to be performed at the cover beams.

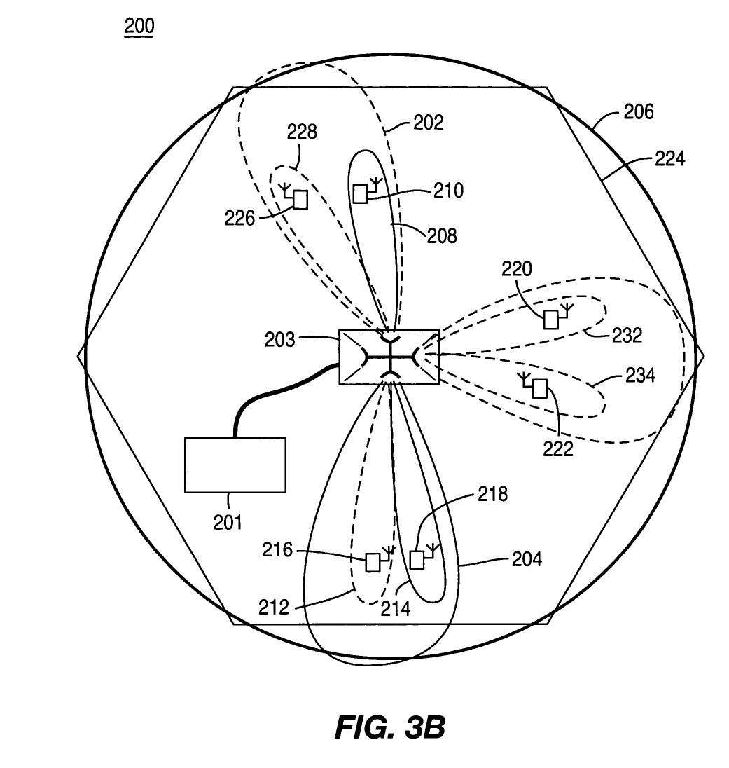

Referring now to FIG. 4 there is shown a block diagram of a system 300 for utilizing nested beams in wireless communication systems in accordance with the present invention. The system includes an antenna 302, a control unit 304, and a transceiver 306. The system 300 may be implemented in a WTRU, a base station, or any other device configured to transmit and receive signals through wireless connections. The antenna 302 is configured to generate at least one cover beam within which at least one center beam is provided, as described above. The parameters of the cover beam and the center beam are adjusted by the control unit 304. For example, the parameters adjusted for each beam may include a gain and direction. To efficiently perform wireless communications, the control using 304 preferably adjusts parameters in a center beam to maintain acceptable QOS in user data transmissions/receptions based on measurements or other information provided by a cover beam. The system 300 may include a measurement unit 308 for performing physical measurements that may be used by the control unit 304 in adjusting parameters of a cover beam and/or a center beam. The control unit 304 may also be configured to obtain WTRU location information and adjust or deploy additional cover/center beams to provide service for WTRUs of new users.

It is important to note that the present invention may be implemented in any type of wireless communication system. By way of example, the present invention may be implemented in UMTS-TDD, UMTS-FDD, CDMA2000, TDSCDMA, GSM, WLAN, WPAN, WMAN or any other type of wireless communication system. Further, although the features and elements of the present invention are described in the preferred embodiments in particular combinations, each feature or element can be used alone or in various combinations with or without other features and elements of the present invention.

1. A system for enhancing communication between a transmitter and a receiver, the system comprising:
an antenna configured to transmit at least one cover beam having a wide coverage area and at least one center beam nested within the cover beam wherein the cover beam and the center beam are independently steerable; and,
a control unit for controlling parameters of the cover beam and the center beam.

2. The system of claim 1 further comprising a measurement unit for performing physical measurements to be used in controlling parameters of the cover beam and the center beam.

3. The system of claim 2 wherein the measurement unit is configured to perform physical measurements on a signal received by the cover beam.

4. The system of claim 1 wherein the system transmits data associated with paging messages, multicast messages, and broadcast messages using the at least one cover beam.

5. The system of claim 1 wherein the control unit is configured to locate wireless transmit/receive units (WTRUs) not currently interfacing with said system using the at least one cover beam.

6. The system of claim 5 wherein the control unit is configured to deploy a center beam focused on a WTRU once the WTRU has been located using the at least one cover beam.

7. The system of claim 1 wherein the control unit is configured to use the at least one cover beam to obtain information regarding WTRUs interfacing with said system.

8. The system of claim 7 wherein the control unit is configured to adjust parameters of center beams associated with WTRUs for which the control unit has obtained information.

9. The system of claim 1 wherein the cover beam and center beam are steered jointly.

10. The system of claim 1 wherein the antenna transmits an omni-directional beam in addition to the cover beam and center beam.

11. The system of claim 1 wherein the at least one cover beam is swept across a coverage area.

12. A method for enhancing communication between a transmitter and a receiver, the method comprising:
generating at least one cover beam having a wide coverage area and at least one center beam nested within the cover beam wherein the cover beam and the center beam are independently steerable; and,
switching between the at least one cover beam and its respective at least one center beam for receiving and transmitting wireless signals depending on the nature of the signal.

13. The method of claim 12 further comprising the step of performing physical measurements to control parameters of the center beam and the cover beam.

14. The method of claim 13 further comprising the step of adjusting the center beam and the cover beam in an elevation dimension based on said physical measurements.

15. The method of claim 13 further comprising the step of adjusting the center beam and the cover beam in an azimuth dimension based on said physical measurements.

16. The method of claim 13 further comprising the step of adjusting a power level at which the cover beam and the center beam are transmitted based on said physical measurements.

17. The method of claim 13 further comprising the step of adjusting a direction of the cover beam and the center beam based on said physical measurements.

18. The method of claim 13 further comprising the step of performing physical measurements using the cover beam and adjusting parameters of the center beam based on said physical measurements.

19. The method of claim 18 further comprising the step of adjusting the center beam in an elevation dimension based on said physical measurements.

20. The method of claim 18 further comprising the step of adjusting the center beam in an azimuth dimension based on said physical measurements.

21. The method of claim 18 further comprising the step of adjusting a power level at which the center beam is transmitted based on said physical measurements.

22. The method of claim 18 further comprising the step of adjusting a direction of the center beam based on said physical measurements.

23. The method of claim 18 further comprising the step of performing the physical measurements while tracking the locations of wireless transmit/receive units (WTRUs) and wherein said physical measurements are WTRU specific based on wireless conditions for each WTRU.

24. The method of claim 12 further comprising the step of transmitting paging, multicast, and broadcast messages using said cover beam.

25. The method of claim 12 further comprising the step of tracking WTRU locations using said cover beam.

26. The method of claim 25 further comprising the step of transmitting data signals to and receiving data signals from WTRU having a known location using at least one center beam.
